(19) United States
(12) Patent Application Publication
(10) Pub. No.: US 2023/0343119 A1
(43) Pub. Date: Oct. 26, 2023

(54) CAPTURED DOCUMENT IMAGE ENHANCEMENT

(71) Applicant: Hewlett-Packard Development Company, L.P., Spring, TX (US)

(72) Inventors: Lucas Nedel Kirsten, Porto Alegre (BR); Guilherme Megeto, Porto Alegre (BR); Augusto Valente, Sao Paulo (BR); Karina Bogdan, Porto Alegre (BR); Rovilson Junior, Porto Alegre (BR)

(21) Appl. No.: 17/273,416

(22) PCT Filed: Feb. 26, 2021
(86) PCT No.: PCT/US2021/019809

§ 371 Date: Mar. 4, 2021

(51) Int. Cl. G06V 30/12; G06V 30/18; G06V 10/82

(52) U.S. Cl. CPC G06V 30/133; G06V 30/18124; G06V 10/82; G06V 30/14

(57) ABSTRACT

A contextual feature matrix that aggregates contextual information within a captured image of a document at multiple scales is generated using a multiscale aggregator machine learning model. Pixel-wise enhancement curves for the captured image are estimated based on the contextual feature matrix using an enhancement curve prediction machine learning model. The pixel-wise enhancement curves are iteratively applied to the captured image to enhance the document within the captured image.

### BACKGROUND

While information is increasingly communicated in electronic form with the advent of modern computing and networking technologies, physical documents, such as printed and handwritten sheets of paper and other physical media, are still often exchanged. Such documents can be converted to electronic form by a process known as optical scanning. Once a document has been scanned as a digital image, the resulting image may be archived, or may undergo further processing to extract information contained within the document image so that the information is more usable. For example, the document image may undergo optical character recognition (OCR), which converts the image into text that can be edited, searched, and stored more compactly than the image itself.

### BRIEF DESCRIPTION OF THE DRAWINGS

FIG. 1 is a diagram of an example process for enhancing a document within a captured image.

FIG. 2 is a diagram of an example encoder machine learning model that can be used in the process of FIG. 1.

FIG. 3 is a diagram of an example multiscale aggregator machine learning model that can be used in the process of FIG. 1.

FIG. 4 is a diagram of an example decoder machine learning model that can be used in the process of FIG. 1.

FIG. 5 is a diagram of an example process for training and testing an enhancement curve prediction machine learning model that can be used in the process of FIG. 1.

FIG. 6 is a diagram of an example computer-readable data storage medium storing program code for enhancing a document within a captured image.

FIG. 7 is a flowchart of an example method for enhancing a document within a captured image.

FIG. 8 is a block diagram of an example computing device that can enhance a document within a captured image.

### DETAILED DESCRIPTION

As noted in the background, a physical document can be scanned as a digital image to convert the document to electronic form. Traditionally, dedicated scanning devices have been used to scan documents to generate images of the documents. Such dedicated scanning devices include sheetfed scanning devices, flatbed scanning devices, and document camera scanning devices, as well as multifunction devices (MFDs) or all-in-one (AIO) devices that have scanning functionality in addition to other functionality such as printing functionality.

However, with the near ubiquitousness of smartphones and other usually mobile computing devices that include cameras and other types of image capturing sensors, documents are often scanned with such non-dedicated scanning devices. A difficulty with scanning documents using a non-dedicated scanning device is that the document images are generally captured under non-optimal lighting conditions. Stated another way, a non-dedicated scanning device may capture an image of a document under varying environmental lighting conditions due to a variety of different factors.

For example, varying environmental lighting conditions may result from the external light incident to the document varying over the document surface, because of a light source being off-axis from the document, or because of other physical objects casting shadows on the document. The physical properties of the document itself can contribute to varying environmental lighting conditions, such as when the document has folds, creases, or is otherwise not perfectly flat. The angle at which the non-dedicated scanning device is positioned relative to the document during image capture can also contribute to varying environmental lighting conditions.

Capturing an image of a document under varying environmental lighting conditions can imbue the captured image with undesirable artifacts. For example, such artifacts can include darkened areas within the image in correspondence with shadows discernibly or indiscernibly cast during image capture. Existing approaches for enhancing document images captured by non-dedicated scanning devices to remove artifacts from the scanned images can result in less than satisfactory image enhancement. As one example, the approaches may remove portions of the document itself, in addition to artifacts resulting from environmental lighting conditions.

Techniques described herein can ameliorate these and other issues in enhancing a captured image of a document to counteract the effects of varying environmental lighting conditions under which the document image was captured. The techniques employ a novel multiscale aggregator machine learning model to generate a contextual feature matrix that aggregates contextual information within a captured document image at multiple scales. Pixel-wise enhancement curves for the captured image can then be better estimated on the basis of this contextual feature matrix. Iterative application of the pixel-wise enhancement curves to the captured image results in enhancement of the document within the captured image that can be objectively and subjectively superior to existing approaches.

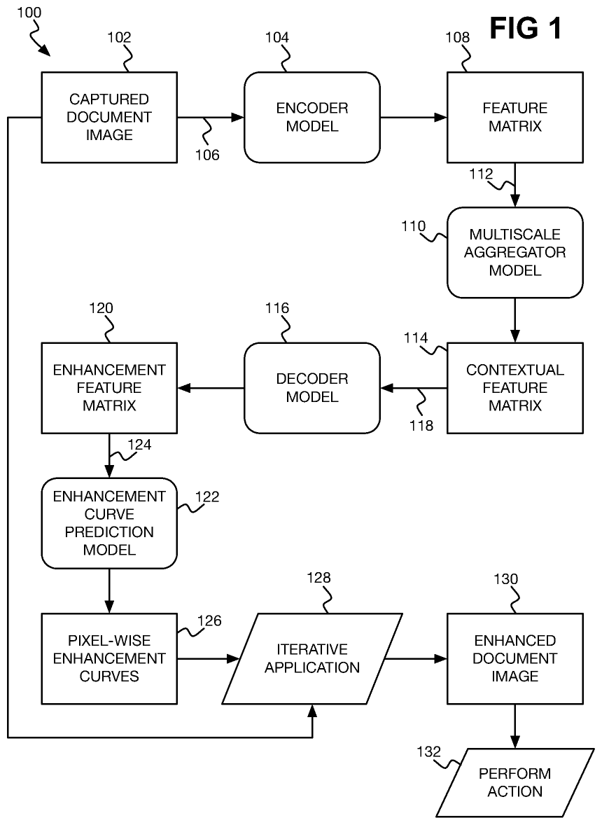

FIG. 1 shows an example process 100 for enhancing a captured image 102 of a document. For example, the image capturing sensor of a smartphone or other device may be used to capture the image 102 of the document. The captured image 102 may be in an electronic image file format such as the joint photographic experts group (JPEG) format, the portable network graphics (PNG) format, or another file format.

The captured document image 102 may have a resolution of H pixels high by W pixels wide. Each pixel of the captured image 102 may have a value in each of CA color channels. For example, there may be C=3 color channels in the case in which the image 102 is represented in the red-green-blue (RGB) color space having red, green, and blue color channels. Mathematically, the captured document image 102 may be expressed as I∈ [symbol] ^{H×W×C}.

An encoder model 104 is applied (106) to the captured document image 102 to downsample the captured image 102 into a feature matrix 108 having a reduced resolution as compared to the image 102. The encoder model 104 may be a machine learning model like a convolutional neural network. A particular example of the encoder model 104 is described later in the detailed description. The feature matrix 108 can also be to as a referred to as a feature map, and represents features (e.g., information) of the image 102.

Decreasing the feature resolution produces a more compact feature matrix 108 for improved computational performance, as well as to discard information within the captured image 102 that is not needed within the process 100. The feature matrix 108 can be mathematically expressed as fₛ∈ [symbol] ^{H′×W′×C}^{ₛ}, where H′≤H, W′≤W, and Cₛ is the number of output channels, which is equal to the number of channels output by the encoder model 104. The feature matrix 108 thus has a resolution of H′ pixels high by W′ pixels wide over each output channel. The number of output channels, Cₛ, of the feature matrix 108 can be different than the number of color channels, C, of the image 102. For example, Cₛ may be equal to 64.

A multiscale aggregator model 110 is applied (112) to the feature matrix 108 to aggregate contextual information within the captured document image 102 (as has been downsampled to the feature matrix 108) at multiple scales, within a contextual feature matrix 114. The multiscale aggregator model 110 can be a machine learning model like a convolutional neural network. A particular example of the multiscale aggregator model 110 is described later in the detailed description. The contextual feature matrix 114 can also be referred to as a contextual feature map, and represents aggregated contextual information of the features of the image 102.

The multiscale aggregator model 110 specifically encloses multiscale features from the captured document image 102. These contextual and aggregated features can provide an expanding view of the pixel neighborhood of the captured image 102 by expanding the receptive field of convolutional operations applied to the features. The contextual feature matrix 114 thus considers different scales of the image 102 in correspondence with the expanding receptive field of the convolutions. The multiscale aggregator model 110 therefore exposes and aggregates contextual information within the downscaled feature maps of the feature matrix 108 by progressively increasing receptive field scales to obtain a wider view of these maps and gather information at these multiple scales.

The contextual feature matrix 114 can be mathematically expressed as c∈ [symbol] ^{H′×W′×2C}^{ₛ}. The contextual feature matrix 114 output by the multiscale aggregator model 110 therefore has the same resolution of H′ pixels high by W′ pixels wide as the feature matrix 108 input into the model 110. However, the contextual feature matrix 114 has twice the number of output channels as the feature matrix 108. That is, the contextual feature matrix 114 has 2Cₛ output channels.

A decoder model 116 is applied (118) to the contextual feature matrix 114 to upsample the contextual feature matrix 114 into an enhancement feature matrix 120. The decoder model 116 may be a machine learning model like a convolutional neural network. A particular example of the decoder model 116 is described later in the detailed description. The enhancement feature matrix 120 can also be referred to as an enhancement feature map, and represents features (e.g., information) of the captured document image 102 on which basis enhancement curves in particular can be estimated for the image 102.

The contextual feature matrix 114 is expanded into the enhancement feature matrix 120 to have a resolution corresponding to the originally captured document image 102. That is, the enhancement feature matrix 120 has a resolution equal to that of the captured document image 102. Such expansion permits predictions to be made for the captured image 102 on a per-pixel basis. The enhancement feature matrix 120 can be mathematically expressed as fₑ∈ [symbol] ^{H×W×C}^{ₑ}. The enhancement feature matrix 120 thus has a resolution of H pixels high by W pixels wide at each of Cₑ output channels. The number of output channels, Cₑ, of the enhancement feature matrix 120 can be different from the number of output channels, Cₛ, of the contextual feature matrix 114.

An enhancement curve prediction model 122 is applied (124) to the enhancement feature matrix 120 to estimate pixel-wise enhancement curves 126 for the captured document image 102. The enhancement curve prediction model 122 may be a machine learning model like a convolutional neural network, such as that described in C. Guo et al., “Zero-Reference Deep Curve Estimation for Low-Light Image Enhancement,” Computer Vision and Pattern Recognition (CVPR) (2020). However, unlike the convolutional neural network described in this reference, the enhancement curve prediction model 122 may be a supervised model that can be trained and tested as described later in the detailed description. In one implementation, three pixel-wise enhancement curves 126 may be estimated.

The enhancement curves 126 are pixel-wise such transformations in that each provides an adjustment value a for each image pixel. There are multiple pixel-wise enhancement curves 126 in that the prediction model 122 estimates n pixel-wise enhancement curves 126, or transformations. Therefore, for n pixel-wise enhancement curves 126, each enhancement curve Aᵢ, where 0<i≤n, Aᵢ∈ [symbol] ^{H×W×C}, will contain values α_{hw}∈[−1,1], where 0≤h<H and 0≤w<W. Having multiple enhancement curves 126 provides for improved image enhancement, since each curve 126 may in effect focus on different parts of the image and/or in effect focus on reducing different types of noise or other artifacts from the captured document image 102.

The pixel-wise enhancement curves 126 are iteratively applied (128) to the captured document image 102, resulting in an enhanced document image 130. Each enhancement transformation can be mathematically expressed as Eᵢ∈ [symbol] ^{H×W×C}, and is applied to a previous enhancement, where the original enhancement E₀ is the captured document image 102 itself, or I, such as in normalized form I∈[0,1]. The result at each iteration can be defined as Eᵢ=Eᵢ₋₁+AᵢEᵢ₋₁(1−Eᵢ₋₁). The second term of this equation works as a highlight-and-diminish operation for the enhanced image Eᵢ₋₁ to remove lowlight exposure and shadow regions and noise.

The process 100 can conclude with performance of an action (132) on the enhanced image 130 of the document. As one example, the enhanced document image 130 may be saved in an electronic image file, in the same or different format as the captured document image 102. As another example, the enhanced document image 130 may be printed on paper or other printable media, or displayed on a display device for user viewing. Other actions that can be performed include optical character recognition (OCR), as well as other types of image enhancement.

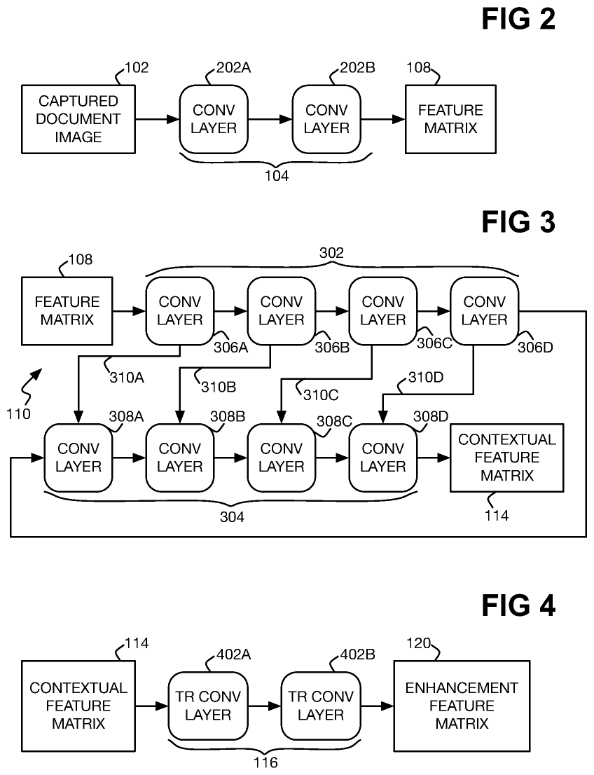

FIG. 2 shows an example of the encoder model 104 that can be used in the process 100. The encoder model 104 is specifically a convolutional neural network having convolutional layers 202A and 202B, which are collectively referred to as the convolutional layers 202. While there are two convolutional layers 202 in the example, there may be more than two layers 202.

Each convolutional layer 202 may have a kernel size of 3×3 with a stride of 2, and may include an activation function. The captured document image 102 is thus input to the first convolutional layer 202A, and the output of the first convolutional layer 202B is input to the second convolutional layer 202B. The output of the second convolutional layer 202B is the feature matrix 108.

FIG. 3 shows an example of the multiscale aggregator model 110 that can be used in the process 100. The multiscale aggregator model 110 is specifically a convolutional neural network having a first convolutional layer sequence 302 followed by a second convolutional layer sequence 304. The feature matrix 108 is input to the first sequence 302, and the contextual feature matrix 114 is output by the second sequence 304.

The first sequence 302 includes first convolutional layers 306A, 306B, 306C, and 306D, collectively referred to as the first convolutional layers 306, and the second sequence includes second convolutional layers 308A, 308B, 308C, and 308D, collectively referred to as the second convolutional layers 308. Skip connections 310A, 310B, 310C, and 310D, collectively referred to as the skip connections 310, connect the outputs of the first convolutional layers 306 to respective of the second convolutional layers 308, such as via concatenation on the channel axis. While there are four convolutional layers 306, four convolutional layers 308, and four skip connections 310 in the example, there may be more or fewer than four layers 306, four layers 308, and four skip connections 310.

The convolutional layers 306 and 308 can each be a 3×3 convolution. The first convolutional layers 306A, 306B, 306C, and 306D can have kernel dilation factors of 1, 1, 2, and 3, respectively, and the second convolutional layers 308A, 308B, 308C, and 308D can have kernel dilation factors of 8, 16, 1, and 1, respectively. Such kernel dilation factors are consistent with those described in F. Yu et. Al, “Multi-scale Context Aggregation by Dilated Convolutions,” in International Conference on Learning Representations (ICLR) (2016). The convolutional layers 306 and 308 can each have Cₛ output channels. The first convolutional layers 306 can each have Cₛ input channels, whereas the second convolutional layers 308 can each have 2Cₛ input channels as a result of being skip-connected to corresponding first convolutional layers 306, except for the convolutional layer 308A which has Cₛ input channels as the skip-connections can be applied after the convolutional layer operation.

The convolutional layers 306 and 308 can have cumulatively increasing receptive fields of 3×3, 5×5, and 9×9, and so on, for instance. The multiscale aggregator model 110 thus expands the receptive field for feature extraction from 3×3 up to the last cumulative receptive field of the feature resolution, obtained from the last convolutional layer of the multiscale aggregator model 110. That is, the multiscale aggregator model 110 considers different, increasing scales of the receptive field over the convolutional layers 306 and 308. Such receptive field expansion is consistent with that described in L-C Chen et al., “DeepLab: Semantic Image Segmentation with Deep Convolutional Nets, Atrous Convolution, and Fully Connected CRFs,” arXiv:1606.00915 [cs.CV] (2016).

FIG. 4 shows an example of the decoder model 116 that can be used in the process 100. The decoder model 116 is specifically a convolutional neural network having transposed convolutional layers 402A and 402B, which are collectively referred to as the transposed convolutional layers 402. While there are two transposed convolutional layers 402 in the example, there may be more than two layers 402. Furthermore, instead of transposed convolutional layers 402, the layers 402 may each be an upsampling layer followed by a convolutional layer.

Each transposed convolutional layer 402 may have a kernel size of 3×3 with a stride of 2, and may include an activation function. The contextual feature matrix 114 is thus input to the first transposed convolutional layer 402A, and the output of the first transposed convolutional layer 402A is input to the second transposed convolutional layer 402B. The output of the second transposed convolutional layer 402B is the enhancement feature matrix 120.

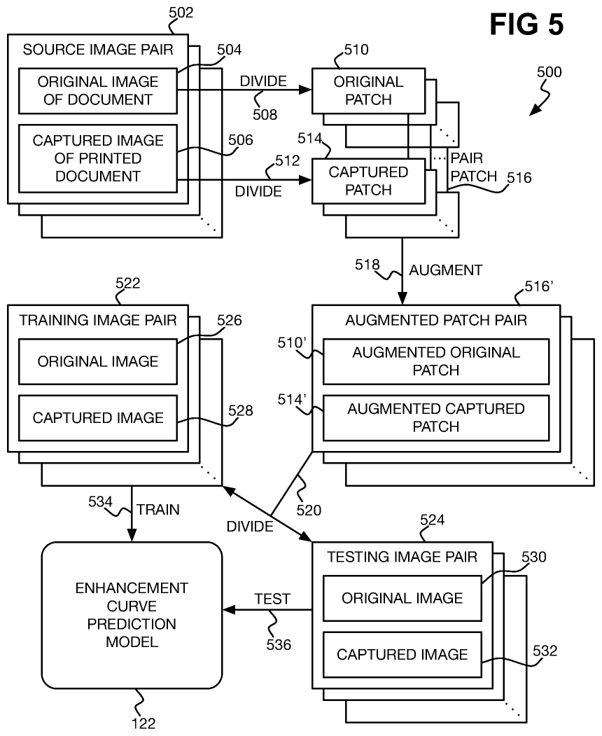

FIG. 5 shows an example process 500 for training and testing the enhancement curve prediction model 122, which may be a convolutional neural network like that of the Guo reference noted above. The process 500 employs source image pairs 502 that each include an original image 504 of a document and a captured image 506 of the document after printing. For example, the original document image 504 of each source image pair 502 may be an electronic image of a document in PNG, JPEG, or another electronic image format. This original image 504 of the document can then be printed on printable media like paper, and a corresponding image 506 of the resultantly printed document captured using a smartphone or other device.

The original image 504 of each source image pair 502 is divided (508) into a number of patches 510, which are referred to as the original patches 510. The captured image 506 of each source image pair 502 is likewise divided (512) into a number of patches 514, which are referred to as the captured patches 514. Therefore, there are patch pairs 516 that each include an original patch 510 and a corresponding captured patch 514. The number of patch pairs 516 is greater than the number of source image pairs 502. For example, 256×256 overlapping patches 510 may be extracted from each original image 504 at a stride of 128 and 256×256 overlapping patches 514 may similarly be extracted from each captured image 506 at a stride of 128. Additionally, the patches 510 and 514 of the patch pairs 516 may each be flipped upside down, and/or processed in another manner, to generate even more patch pairs 516.

The original patch 510 and the captured patch 514 of each patch pair 516 may further be augmented (518) to result in augmented patch pairs 516′ that each include an augmented original patch 510′ and an augmented captured patch 514′. After augmentation, the augmented original patch 510′ and the augmented captured patch 514′ of each patch pair 516′ have the same resolution. By comparison, prior to augmentation, the original patches 510 and the captured patches 514 of the patch pairs 516 may not have the same resolution.

As an example, a sampling of variable window sizes may be evaluated to increase the pixel neighborhood of each original patch 510 and each captured patch 514. Such sliding windows enlarge each original patch 510 and each captured patch 514 to the resolution of the original image 504 and the captured image 506. The sliding windows that may be considered are 256×256 at a stride of 128; 512×512 at a stride of 256; 1024×1024 at a stride 512; and finally, the resolution of the original image 504 and the captured image 506. A Laplacian operator may be applied over the resulting augmented original patch 510′ and augmented captured patch 514′ of each augmented patch pair 516′ to discard samples below a specified gradient threshold.

The augmented patch pairs 516′ are divided (520) into training image pairs 522 and testing image pairs 524. More of the augmented patch pairs 516′ may be assigned as training image pairs 522 than as testing image pairs 524. Each training image pair 522 is thus one of the augmented patch pairs 516′, as is each testing image pair 524. Each training image pair 522 is said to include an original image 526 and a captured image 528, which are the augmented original patch 510′ and the augmented captured patch 514′, respectively, of a corresponding augmented patch pair 516′. Each testing image pair 524 is likewise said to include an original image 530 and a captured image 532, which are the augmented original patch 510′ and the augmented captured patch 514′, respectively, of a corresponding augmented patch pair 516′.

The enhancement curve prediction model 122 is trained (534) using the training image pairs 522. Specifically, the enhancement curve prediction model 122 is trained to generate, for each training image pair 522, pixel-wise enhancement curves that transform the captured image 528 into the corresponding original image 526. A loss function, such as L1 distance, [symbol] =∥I_{GT}−Î∥₁ may be used (i.e., minimized) for such training, where I_{GT} corresponds to an original image 526, and Î corresponds to the captured image 528 after enhancement via iterative application of predicted pixel-wise enhancement curves. After the enhancement curve prediction model 122 has been trained, the model 122 can then be tested (536) using the testing image pairs 524.

In another implementation, the enhancement curve prediction model 122 can be trained and tested on the basis of the source image pairs 502 themselves as training image pairs, as opposed to on the basis of patch pairs 516. In such an implementation, the source image pairs 502 can still be flipped upside down and/or subjected to other processing to yield additional image pairs 502. Furthermore, the source image pairs 502 can still be augmented so that the original images 504 and the captured images 506 have the same resolution.

For training and testing of the enhancement curve prediction model 122, the captured images 528 and 530 of the training and testing image pairs 522 and 524 are first converted to enhancement feature matrices using the encoder, multiscale, and decoder models 104, 110, and 116 that have been described, and then specifically trained and tested using these feature matrices. The encoder, multiscale, and decoder models 104, 110, and 116 can thus be considered a backbone neural network to which the enhancement curve prediction model 122 is a predictive head neural network or module. Such a trained enhancement curve prediction model 122, in conjunction with the multiscale aggregator model 110 (and decoder and encoder models 104 and 116), has been shown to result in improved captured document image enhancement as compared to an unsupervised enhancement curve prediction model used in conjunction with a more basic feature-extracting convolutional neural network as in the Guo reference noted above.

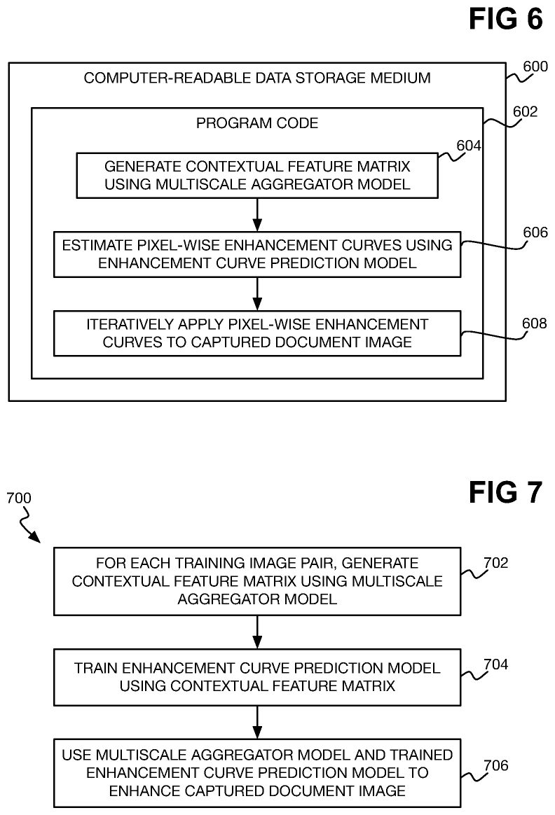

FIG. 6 shows an example computer-readable data storage medium 600 storing program code 602 executable by a processor to perform processing for enhancing a captured document image. The processor may be part of a smartphone or other computing device that captures an image of a document. The processor may instead be part of a different computing device, such as a cloud or other type of server to which the image-capturing device is communicatively connected over a network such as the Internet. In this case, the device that captures a document image is not the same device that enhances the captured document image.

The processing includes generating a contextual feature matrix that aggregates contextual information within a captured image of a document at multiple scales, using a multiscale aggregator machine learning model (604). The processing includes estimating pixel-wise enhancement curves for the captured image based on the contextual feature matrix, using an enhancement curve prediction machine learning model (606). The processing includes iteratively applying the pixel-wise enhancement curves to the captured image to enhance the document within the captured image (608).

FIG. 7 shows an example method 700. The method 700 can be implemented as program code stored on a non-transitory computer-readable data storage medium and executable by a processor of a computing device to enhance a captured document image. As in FIG. 6, the computing device may be the same or different computing device as that which captured the image of the document to be enhanced.

The method 700 includes, for each of a number of training image pairs that each include an original image of a document and a captured image of the document as printed, generating a contextual feature matrix that aggregates contextual information within the captured image at multiple scales, using a multiscale aggregator machine learning model (702). The method 700 includes training an enhancement curve prediction model based on the contextual feature matrices for the training image pairs (704). The enhancement curve prediction model estimates, for each training image pair, pixel-wise enhancement curves that are iteratively applied to enhance the captured image to correspond to the original image. The method 700 includes then using the multiscale aggregator machine learning model and the trained enhancement curve prediction model to enhance a captured document image (706).

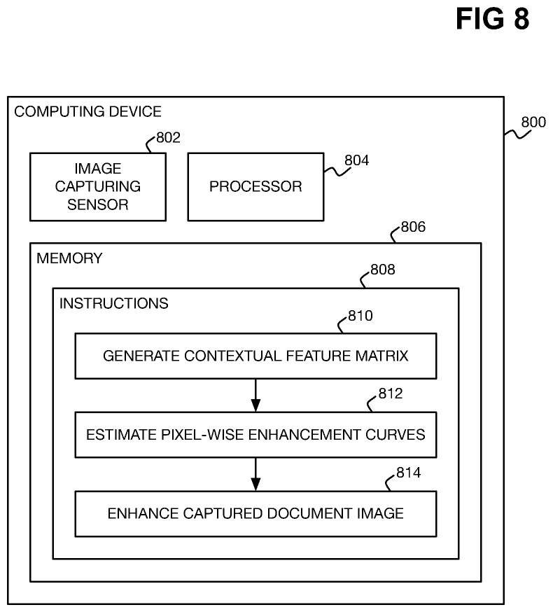

FIG. 8 is a block diagram of an example computing device 800 that can enhance a document within a captured image. The computing device 800 may be a smartphone or another type of computing device that can capture an image of a document. The computing device 800 includes an image capturing sensor 802, such as a digital camera, to capture an image of a document. The computing device 800 further includes a processor 804, and a memory 806 storing instructions 808.

The instructions 808 are executable by the processor 804 to generate a contextual feature matrix that aggregates contextual information within the captured image of a document at multiple scales, using a multiscale aggregator machine learning model (810). The instructions 808 are executable by the processor 804 to estimate pixel-wise enhancement curves for the captured image based on the contextual feature matrix, using an enhancement curve prediction machine learning model (812). The instructions 808 are executable by the processor 804 to enhance the document within the captured image by iteratively applying the pixel-wise enhancement curves to the captured image (814).

Techniques have been described for enhancing a captured image of a document. The techniques employ a multiscale aggregator model that generates a contextual feature matrix aggregating contextual information within the captured document image. Pixel-wise enhancement curves that are iteratively applied to the captured document image can be better estimated using an enhancement curve prediction model on the basis of such a contextual feature matrix. Such improved pixel-wise enhancement curve prediction is also provided via training the enhancement curve prediction model using training image pairs that each include an original image of a document and a captured image of the document as printed.

We claim:

1. A non-transitory computer-readable data storage medium storing program code executable by a processor to perform processing comprising:
generating a contextual feature matrix that aggregates contextual information within a captured image of a document at multiple scales, using a multiscale aggregator machine learning model;
estimating a plurality of pixel-wise enhancement curves for the captured image based on the contextual feature matrix, using an enhancement curve prediction machine learning model; and
iteratively applying the pixel-wise enhancement curves to the captured image to enhance the document within the captured image.

2. The non-transitory computer-readable data storage medium of claim 1, wherein the processing further comprises:
performing an action on the enhanced document within the captured image.

3. The non-transitory computer-readable data storage medium of claim 1, wherein the multiscale aggregator machine learning model comprises a convolutional neural network having a plurality of convolutional layers with expanding receptive feature resolution fields.

4. The non-transitory computer-readable data storage medium of claim 3, wherein the convolutional layers comprise a first sequence of first convolutional layers and a second sequence of second convolutional layers following the first sequence,
wherein each first convolutional layer is skip-connected to a different corresponding second convolutional layer.

5. The non-transitory computer-readable data storage medium of claim 1, wherein the processing further comprises:
applying an encoder machine learning model to the captured image to downsample the captured image into a feature matrix having a reduced resolution as compared to the captured image,
wherein generating the contextual feature matrix comprises applying the multiscale aggregator machine learning model to the feature matrix.

6. The non-transitory computer-readable data storage medium of claim 5, wherein the encoder machine learning model comprises a convolutional neural network having a plurality of convolutional layers that each include an activation function.

7. The non-transitory computer-readable data storage medium of claim 5, wherein the processing further comprises:
applying a decoder machine learning model to the contextual feature matrix to upsample the contextual feature matrix into an enhancement feature matrix having a resolution corresponding to the captured image,
wherein estimating the pixel-wise enhancement curves for the captured image comprises iteratively applying the enhancement curve prediction machine learning model to the enhancement feature matrix.

8. The non-transitory computer-readable data storage medium of claim 7, wherein the decoder machine learning model comprises a convolutional neural network having a plurality of transposed convolutional layers that each include an activation function.

9. The non-transitory computer-readable data storage medium of claim 1, wherein the enhancement curve prediction machine learning model comprises a convolutional neural network that is trained and tested using a plurality of image pairs that each comprise an original image of a document and a captured image of the document as printed.

10. A method comprising:
for each of a plurality of training image pairs that each comprise an original image of a document and a captured image of the document as printed, generating a contextual feature matrix that aggregates contextual information within the captured image at multiple scales, using a multiscale aggregator machine learning model;
training an enhancement curve prediction model based on the contextual feature matrices for the training image pairs, the enhancement curve prediction model estimating for each training image pair a plurality of pixel-wise enhancement curves that are iteratively applied to enhance the captured image to correspond to the original image; and
using the multiscale aggregator machine learning model and the trained enhancement curve prediction model to enhance a captured document image.

11. The method of claim 10, further comprising:
for each of a plurality of source image pairs that each comprise an original source image of a document and a captured source image of the document as printed, dividing the original source image and the captured source image into original patches and captured patches, respectively, yielding a plurality of patch pairs that each comprise one of the original patches and a respective one of the captured patches,
wherein each training image pair corresponds to one of the patch pairs.

12. The method of claim 11, further comprising:
augmenting the original patch and the captured patch of each patch pair to upsample the original patch and the captured patch to a same resolution,
wherein each training image pair is one of the patch pairs after augmentation.

13. The method of claim 10, further comprising:
dividing a plurality of source image pairs that each comprise an original image of a document and a captured image of the document as printed into the plurality of training image pairs and a plurality of testing image pairs; and
testing the trained enhancement curve prediction model using the testing image pairs.

14. A computing device comprising:
an image capturing sensor to capture an image of a document;
a processor; and
a memory storing instructions executable by the processor to:
generate a contextual feature matrix that aggregates contextual information within the captured image of the document at multiple scales, using a multiscale aggregator machine learning model;
estimate a plurality of pixel-wise enhancement curves for the captured image based on the contextual feature matrix, using an enhancement curve prediction machine learning model; and
enhance the document within the captured image by iteratively applying the pixel-wise enhancement curves to the captured image.

15. The computing device of claim 14, wherein the instructions are executable by the processor to further:
apply an encoder machine learning model to the captured image to downsample the captured image into a feature matrix having a reduced resolution as compared to the captured image, the multiscale aggregator machine learning model applied to the feature matrix to generate the contextual feature matrix; and
apply a decoder machine learning model to the contextual feature matrix to upsample the contextual feature matrix into an enhancement feature matrix having a resolution corresponding to the captured image, the enhancement curve prediction machine learning model applied to the enhancement feature matrix to estimate the pixel-wise enhancement curves for the captured image.
